(19) United States
(12) Patent Application Publication
(10) Pub. No.: US 2019/0065872 A1
(43) Pub. Date: Feb. 28, 2019

(54) BEHAVIOR RECOGNITION APPARATUS, LEARNING APPARATUS, AND METHOD AND PROGRAM THEREFOR

(71) Applicant: TOYOTA JIDOSHA KABUSHIKI KAISHA, Toyota-shi (JP)

(72) Inventors: Masao YAMANAKA, Tokyo (JP); Toshifumi NISHIJIMA, Kasugai-shi (JP)

(73) Assignee: TOYOTA JIDOSHA KABUSHIKI KAISHA, Toyota-shi (JP)

(21) Appl. No.: 16/102,258

(22) Filed: Aug. 13, 2018

(30) Foreign Application Priority Data
Aug. 25, 2017 (JP) 2017-162660

(51) Int. Cl. G06K 9/00; B60W 40/09; G06K 9/62; G06F 15/18

(52) U.S. Cl. CPC G06K 9/00845; G06F 15/18; G06K 9/6277; B60W 40/09

(57) ABSTRACT

A behavior identification apparatus comprises an acquiring unit that acquires occupant information on the occupant in the vehicle, from each frame image of the moving image; a first calculating unit that calculates, for each frame image of the moving image, a first feature value, which is a feature value based on the occupant information; a second calculating unit that calculates a second feature value, which is a feature value generated by connecting the first feature values for the frame images in a predetermined period; and an identifying unit that identifies the behavior of the occupant in the vehicle using a classifier which is learned in advance so as to determine, from the second feature value, a probability distribution of behavior labels in a predetermined period, and the second feature value calculated by the second feature value calculating unit.

### BACKGROUND OF THE INVENTION

### Field of the Invention

The present invention relates to a behavior recognition apparatus for an occupant in a vehicle, and more particularly, to a behavior recognition apparatus for an occupant in a vehicle that is suitable for estimating the state of the occupant in the vehicle.

### Description of the Related Art

As an example of a method for recognizing a behavior of an occupant in a vehicle, a method in Non Patent Literature 1 has been proposed. In Non Patent Literature 1, a plurality of images having different resolutions (image pyramids) are created from an input image, and points of interest are detected at high density from the acquired image pyramids. Further, for each trajectory acquired by tracking each point of interest in the time direction, a plurality of types of image feature values, such as HOG, HOF and MBH, are calculated. Furthermore, these image feature values are connected in the dimensional direction, and converted into image feature values having higher description capabilities using bag-of-features representation. Finally, a classifier is learned using a nonlinear SVM, of which input is the image feature value acquired for each behavior to be identified.

As another example of a method of recognizing behavior of an occupant in a vehicle, a method in Non Patent Literature 2 has been proposed. In Non Patent Literature 2, the position of a body part at each timing is detected using a depth sensor, and a first feature value is calculated using a hidden Markov model (HMM), of which input is the acquired position of the body part. Further, the acquired first feature value is converted into a second feature value (Fisher vector) which has higher description capability, by applying a Fisher kernel function. Finally, a classifier is learned using a nonlinear SVM, of which input is the second feature value calculated for each behavior to be identified.

As another example of a method for recognizing behavior of an occupant in a vehicle, a method in Non Patent Literature 3 has been proposed. In Non Patent Literature 3, a body part at each timing is detected using a TOF type sensor, and a feature value is calculated based on the sequence relationship of the distances among acquired body parts. Further, a classifier is learned using the random forest method, of which input is the acquired feature value. Finally, a probability density, with respect to the identification target category at each timing by the acquired classifier, is integrated in the time direction and the probability thereof is increased, so as to recognize the behavior of the occupant in the vehicle.
[Non Patent Literature 1] H. Wang, A. Kilaser, C. Schmid. “Dense Trajectories and Motion Boundary Descriptors for Action Recognition”, International Journal of Computer Vision (IJCV), 103, pp. 60-79, 2013.
[Non Patent Literature 2] Y. Goutsu et al., “Gesture recognition using hybrid generative discriminative approach with Fisher Vector”, IEEE International Conference on Robotics and Automation (ICRA), 2015.
[Non Patent Literature 3] M. Yamanaka et al., “Driver's Behavior Recognition Based on the Global Architecture of Human Parts Position”, The 22th Symposium on Sensing via Image Information (SSII), 2016.
[Non Patent Literature 4] M. Schwarz et al., “RGB-D Object Recognition and Pose Estimation Based on Pre-Trained Convolutional Neural Network Features”, ICRA2015.
[Non Patent Literature 5] A. Toshev et al., “Human Pose Estimation via Deep Neural Networks”, CVPR2014.
[Non Patent Literature 6] S. Hochreiter et al., “Long Short-Term Memory”, Neural Computation archive, 1997.
[Non Patent Literature 7] F. A. Gers et al., “Continual Prediction using LSTM with Forget Gates”, Neural Nets WIRN Vietri-99.
[Non Patent Literature 8] F. Gers et al., “Learning Precise Timing with LSTM Recurrent Networks”, Journal of Machine Learning Research, 2002.

### SUMMARY OF THE INVENTION

However, in the case of Non Patent Literature 1, which extracts the high density of points of interest from an image space and calculates a plurality of types of image feature values for each of the acquired trajectories, the volume of the acquired feature values becomes enormous, and a lengthy period of time is required not only for learning the classifier, but also for performing identification processing using this classifier.

In the case of Non Patent Literature 2, in which the positions of the body parts at each timing are detected using the depth sensor, and a hidden Markov model (HMM), of which input is the acquired positions of body parts, is used, it is effective to recognize a behavior intended by the individual in the moving image, such as gesture recognition, but it is difficult to recognize a dangerous behavior which is unintended by the individual in the moving image.

Further, in the case of Non Patent Literature 3, which applies a random forest method where the positions of body parts at each timing are detected using a TOF type sensor, and the sequence relationship of the distances among acquired human parts is used as the feature values, it is difficult to recognize a behavior which depends on the time-series changes of the state of the occupant in the vehicle (e.g. posture of body, posture of fingers, position of face, orientation of face, line of sight).

With the foregoing in view, it is an object of the present invention to accurately recognize the behavior of an occupant in a vehicle.

An aspect of the present invention is a behavior identification apparatus that identifies a behavior of an occupant in a vehicle based on a moving image obtained by imaging the inside of the vehicle.

The present invention in its one aspect provides a behavior identification apparatus that identifies a behavior of an occupant in a vehicle based on a moving image obtained by imaging an inside of the vehicle, the behavior identification apparatus comprising an occupant information acquiring unit configured to acquire occupant information on the occupant in the vehicle, from each frame image of the moving image; a first feature value calculating unit configured to calculate, for each frame image of the moving image, a first feature value, which is a feature value based on the occupant information; a second feature value calculating unit configured to calculate a second feature value, which is a feature value generated by connecting the first feature values for the frame images in a predetermined period; and an identifying unit configured to identify the behavior of the occupant in the vehicle using a classifier which is learned in advance so as to determine, from the second feature value, a probability distribution of behavior labels in a predetermined period, and the second feature value calculated by the second feature value calculating unit.

The identifying unit may output the probability distribution itself, which is acquired from the classifier, or may determine and output, as the behavior of the occupant in the vehicle, a behavior label indicating the maximum value in the probability distribution.

Another aspect of the present invention is a learning apparatus for learning a classifier that can be used for the above mentioned behavior identification apparatus.

The present invention in its another aspect provides a learning apparatus, comprising an occupant information acquiring unit configured to acquire occupant information on an occupant in a vehicle from each frame image of a moving image obtained by imaging an inside of the vehicle; a correct behavior input unit configured to acquire a correct behavior of the occupant in the vehicle in each frame image; a probability distribution calculating unit configured to calculate a probability distribution which indicates a ratio of each correct behavior performed by the occupant in the vehicle in the frame images in a predetermined period; a first feature value calculating unit configured to calculate, for each frame image, a first feature value which is a feature value based on the occupant information; a second feature value calculating unit configured to calculate a second feature value which is a feature value generated by connecting the first feature values for the frame images in a predetermined period; and a learning unit configured to learn a classifier which identifies a probability distribution of each behavior performed by the occupant in the vehicle for a predetermined period, based on the second feature value calculated by the second feature value calculating unit, and the probability distribution calculated by the probability distribution calculating unit.

In the present invention, the information on the occupant in the vehicle includes information on the posture of the occupant in the vehicle acquired from the image obtained by imaging the inside of the vehicle. The image is a visible light image or an infrared image, for example. The visible light image or the infrared image and the distance image may be combined. Examples of the information on the posture of the occupant in the vehicle include the positions of the head, neck, shoulder, elbow, wrist, palm, hip joint, knee, ankle and the like, (center position of each part). Other examples of the information on the posture of the occupant in the vehicle include the head region, orientation of face, line of sight, hand (finger) region and shape of a finger.

The first feature value is a feature value acquired from one frame image, in other words, a feature value acquired from the information on the occupant in the vehicle at a specific timing. The second feature value, on the other hand, is a feature value generated by connecting the first features values in a predetermined period in the time-series direction.

The probability distribution is the distribution of probability when each behavior of the occupant in the vehicle in the predetermined period matches with the plurality of behaviors (behavior labels) determined in advance. The behavior label may appropriately be determined in accordance with a system request, and is, for example, a steering wheel operation, an adjustment of the rear view mirror, an adjustment of the control panel, wearing or removing a seatbelt, an operation of a smartphone, eating and drinking.

According to the present invention, the probability distribution of the behavior labels is determined based on the time-series data, hence even if the identification of a certain behavior is difficult to identify only by information at one timing, the behavior can be appropriately identified.

In the present invention, the positions of a plurality of body parts of the occupant in the vehicle may be used as the occupant information, so that the first feature value is determined based on the relationship of the positions of the body parts. In this case, the first feature value may be determined based on the ranking of the distance among body parts. This ranking feature value does not change when a scale change, rotation or parallel shift occurs, and is little influenced by minute changes. Therefore highly robust recognition can be implemented by using the ranking feature values.

If one of the position of the head region, the orientation of the face, the position of the hand region and the like is used as the occupant information in the present invention, it is preferable that the first feature value is determined by combining this information with the above mentioned feature value based on the positions of the body parts (e.g. ranking feature value). By using the position of the head region, the position of the fingers region, the orientation of the face and the like as well, an even more accurate recognition can be implemented.

The correct behavior input unit of the learning apparatus may acquire the correct behavior of the occupant in the vehicle in the best way possible. For example, the user (human) may provide the correct behavior via the correct behavior input unit. If the labels of the correct behavior are associated with the moving image, the correct behavior input unit may acquire the correct behavior labels associated with the moving image. Critical here is simply to know the correct behavior in each frame, and as a result, the correct behavior in each frame may be acquired, or the start time and the end time of the correct behavior may be acquired.

The learning apparatus may increase a number of learning data by causing minute changes to the first feature value acquired from the moving image. By using the learning data generated by causing minute changes, a classifier, which is little influenced by estimated errors of the positions of the body parts in the identification, can be learned.

The present invention may be regarded as a behavior recognition apparatus or a learning apparatus, which includes at least a part of the above mentioned units. The present invention may also be regarded as a behavior recognition method or a learning method, which executes at least a part of the above mentioned processing. Further, the present invention may be regarded as a computer program that causes a computer to execute these methods, or a computer-readable non-transitory storage medium that stores this computer program. Each unit and processing described above may be combined to constitute the present invention as much as possible.

According to the present invention, a behavior of an occupant in a vehicle can be accurately recognized.

### BRIEF DESCRIPTION OF THE DRAWINGS

FIG. 1A is a functional block diagram of the behavior recognition apparatus 1 according to Embodiment 1;

FIG. 1B is a functional block diagram of a learning apparatus 2 according to Embodiment 1;

FIG. 2 is a flow chart of learning processing performed by the learning apparatus 2;

FIG. 3 is an example of an infrared image which is input to an infrared image input unit 11;

FIG. 4 is an example of a detection result by a body part detecting unit 13;

FIGS. 5A to 5C show diagrams depicting a ranking feature value based on the ranking of the distance among the body parts;

FIG. 6 shows an example of a true value assigning unit 151 assigning a correct behavior label;

FIGS. 7A to 7C show diagrams depicting the probability distribution calculation of correct behavior by the probability distribution calculating unit 253;

FIGS. 8A to 8E show diagrams depicting the probability distribution calculation of correct behavior by the probability distribution calculating unit 153;

FIG. 9 is a diagram depicting the time-series feature value;

FIG. 10 is a diagram depicting the learning data which the learning apparatus 2 uses for learning;

FIG. 11 is a flow chart of behavior recognition processing performed by the behavior recognition apparatus 1;

FIGS. 12A and 12B show functional block diagrams of a behavior recognition apparatus 3 and a learning apparatus 4 according to Embodiment 2; and

FIG. 13 is an example of a detection result by a posture information detecting unit 34.

### DESCRIPTION OF THE EMBODIMENTS

### Embodiment 1

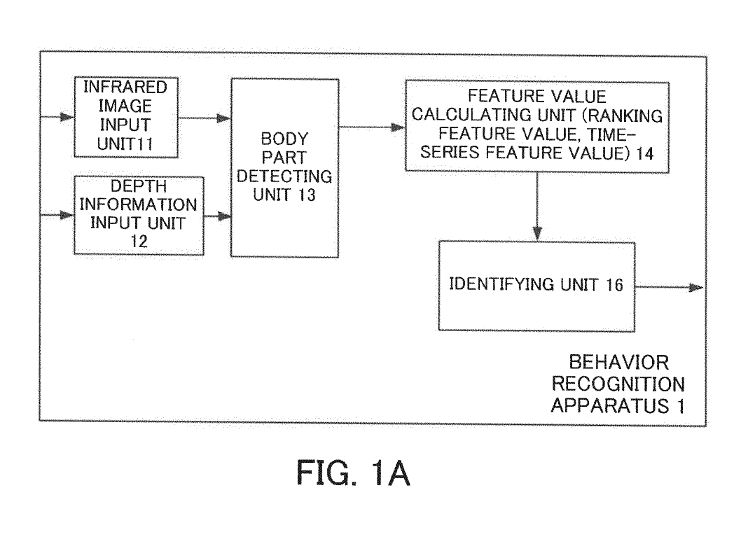

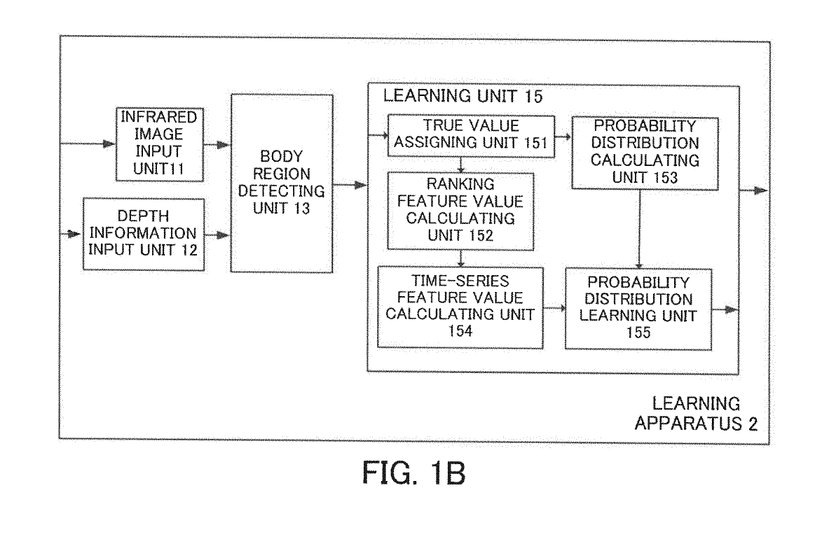

Embodiment 1 of the present invention will be described with reference to the drawings. FIG. 1A is a block diagram depicting a general configuration of a behavior recognition apparatus 1 according to Embodiment 1. The behavior recognition apparatus 1 according to Embodiment 1 can be implemented using a semiconductor integrated circuit (LST). As illustrated in FIG. 1A, the behavior recognition apparatus 1 has an infrared image input unit 11, a depth information input unit 12, a body part detecting unit 13, a feature value calculating unit 14 and an identifying unit 16. These composing elements correspond to the functions performed by the behavior recognition apparatus 1 respectively.

FIG. 1B is a block diagram depicting a general configuration of a learning apparatus 2 to learn for the identifying unit 16. The learning apparatus 2 according to Embodiment 1 is implemented using a semiconductor integrated circuit (LSI). As illustrated in FIG. 1B, the learning apparatus 2 has: an infrared image input unit 11, a depth information input unit 12, a body part detecting unit 13 and a learning unit 15. The learning unit 15 includes a true value assigning unit 151, a ranking feature value calculating unit 152, a probability distribution calculating unit 153, a time-series feature value calculating unit 154 and a probability distribution learning unit 155. Here a functional block of the learning apparatus 2, the same as that of the behavior recognition apparatus 1, is denoted with the same reference number.

Each of these functional units will be described in the following description of learning processing and behavior recognition processing.

Learning Processing

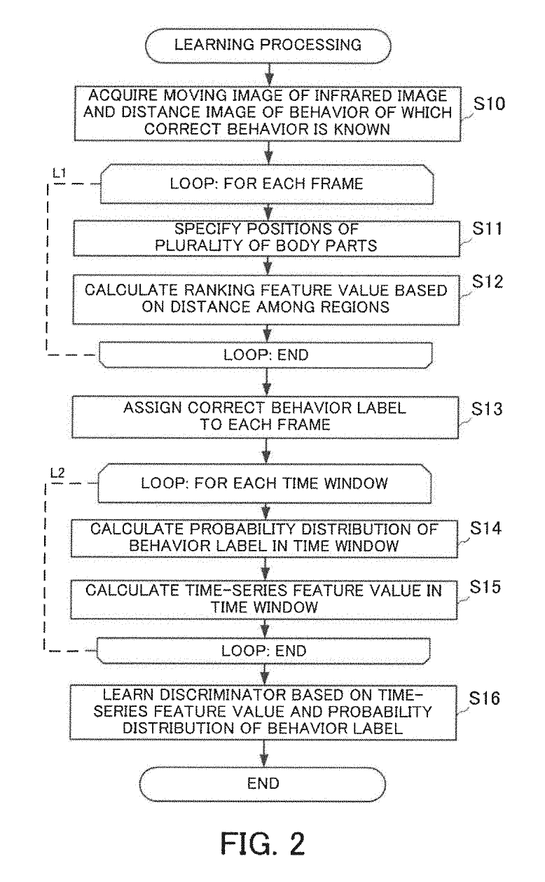

The learning processing performed by the learning apparatus 2 will be described first. FIG. 2 is a flow chart depicting a flow of the learning processing.

In step S10, the learning apparatus 2 acquires moving images of an infrared image, and a depth information (distance image) on a behavior of which correct behavior is known. The infrared image is input from the infrared image input unit 11, the depth information is input from the depth information input unit 12, and the correct behavior is input from the correct behavior input unit 17.

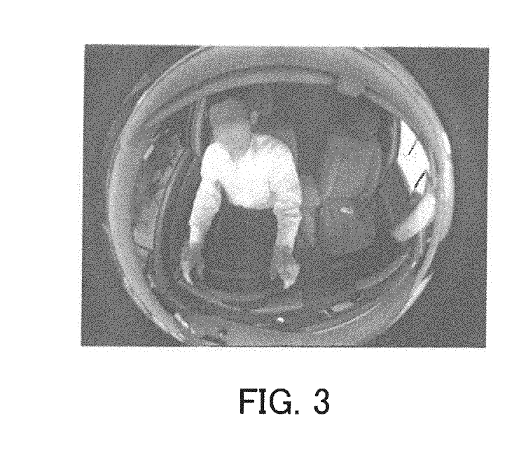

As illustrated in FIG. 3, the infrared image input unit 11 acquires an infrared image inside the vehicle (hereafter infrared image) that is input from outside the behavior recognition apparatus 1, and outputs the infrared image I(t) to the body part detecting unit 13 at timing t (t=1, 2, . . . , T). The infrared image can be acquired from an infrared camera installed inside the vehicle. In Embodiment 1, an infrared image is used, but a visible light image may be used instead.

The depth information input unit 12 acquires the depth information inside the vehicle (hereafter depth information) that is input from outside the behavior recognition apparatus 1, and outputs the depth information D(t) to the body part detecting unit 13 at timing t (t=1, 2, . . . , T). The depth information D(t) can be acquired from an already available commercial stereo camera or TOF type sensor, which is installed inside the vehicle.

The processing of a loop L1, constituted by steps S11 and S12, is performed for each frame of the input moving image.

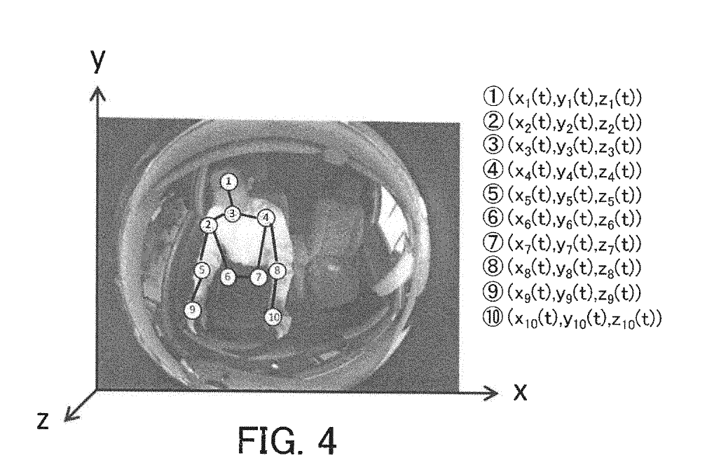

In step S11, as illustrated in FIG. 4, the body part detecting unit 13 detects two-dimensional coordinates (xₘ(t), yₘ(t)) or three-dimensional coordinates (xₘ(t), yₘ(t), zₘ(t)) (m=1, 2, . . . , M) of M number of parts of the occupant in the vehicle, based on the infrared image I(t) acquired by the infrared image input unit 11 and the depth information D(t) acquired by the depth information input unit 12, and outputs the result to the feature value calculating unit 14. The position of the body part is an example of information on the occupant in the vehicle (information on the posture of the occupant in the vehicle), and the body part detecting unit 13 corresponds to the occupant information acquiring unit of the present invention. In Embodiment 1, the body part detecting unit 13 detects a center position of each part of the head, neck, shoulders (left and right), elbows (left and right), palms (left and right) and hip joints (left and right).

Here xₘ(t) indicates a horizontal coordinate of the infrared image I(t) of the m-th part at timing t. yₘ(t) indicates a vertical coordinate of the infrared image I(t) of the m-th part at timing t. zₘ(t) indicates a coordinate in the depth of the m-th part at timing t, and is given by a value on the two-dimensional coordinates (xₘ(t), yₘ(t)) in the depth information D(t).

In concrete terms, to detect the two-dimensional coordinates (xₘ(t), yₘ(t)) (m=1, 2, . . . , M) of M number of parts of the occupant in the vehicle, a classifier C₁, to detect the two-dimensional coordinates (xₘ(t), yₘ(t)) (m=1, 2, . . . , M) of M number of parts of the occupant in the vehicle, is configured using a large volume of learning data, in which the two-dimensional coordinates (xₘ(t), yₘ(t)) (m=1, 2, . . . , M) and the depth direction coordinate zₘ(t) (m=1, 2, . . . , M) of M number of parts of the occupant in the vehicle have been assigned in advance, and the two-dimensional coordinates (xₘ(t), yₘ(t)) (m=1, 2, . . . , M) of the M number of parts of the occupant in the vehicle are detected using the acquired classifier C₁, as described in Non Patent Literature 4.

Alternatively, to detect the two-dimensional coordinates (xₘ(t), yₘ(t)) (m=1, 2, . . . , M) of M number of parts of the occupant in the vehicle, a classifier C₂, to detect the two-dimensional coordinates (xₘ(t), yₘ(t)) (m=1, 2, . . . , M) of M number of parts of the occupant in the vehicle, is configured using a large volume of learning data, in which the two-dimensional coordinates (xₘ(t), yₘ(t)) (m=1, 2, . . . , M) of M number of parts of the occupant in the vehicle have been assigned in advance, and the two-dimensional coordinates (xₘ(t), yₘ(t)) (m=1, 2, . . . , M) of the M number of parts of the occupant in the vehicle may be detected using the acquired classifier C₂, as described in Non Patent Literature 5.

In step S12, the ranking feature value calculating unit 152 calculates the feature value F(t) based on the two-dimensional coordinates (xₘ(t), yₘ(t)) or the three-dimensional coordinates (xₘ(t), yₘ(t), zₘ(t)) (m=1, 2, . . . , M) of M number of parts of the occupant in the vehicle at timing t, acquired by the body part detecting unit 13. In concrete terms, the feature value F(t) is calculated using the following Expression (1).

[Math. 1]

F(t)=(R(D(1,2)),R(D(1,3)), . . . ,R(D(8,9)),R(D(9,10))) (1)

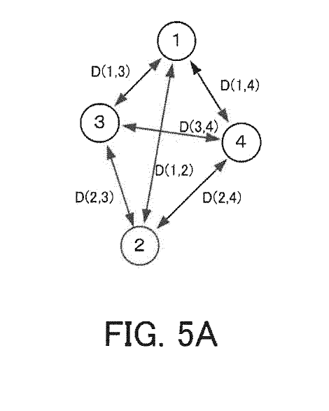

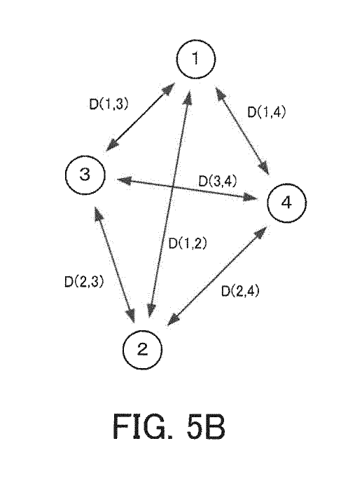

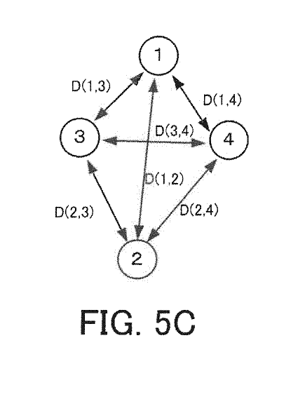

In Expression (1), D(m, n) represents the Euclidean distance between the m-th part and the n-th part in the infrared image space, and R(D(m, n)) indicates the ranking of D(m, n) when D(m, n) is rearranged in descending order, such as D(1, 2), D(1, 3), . . . , D(8, 9), D(9, 10). For example, if there are four parts as indicated in FIG. 5A, and the distance D(t) between each pair of parts is given by

$$\begin{matrix}D ( t ) = ( D ( 1 , 2 ) , D ( 1 , 3 ) , D ( 1 , 4 ) , D ( 2 , 3 ) , D ( 2 , 4 ) , D ( 3 , 4 ) ) \\ = ( 5.5 , 2.6 , 2.8 , 3.5 , 4.3 , 4.0 )\end{matrix}$$

then the feature value F(t) at timing t can be calculated as F(t)=(1, 6, 5, 4, 2, 3).

The feature value F(t) is a feature value based on the ranking of the distance between body parts, and corresponds to the first feature value of the present invention. The ranking feature value calculating unit 152 corresponds to the first feature value calculating unit of the present invention.

The distance between the body parts that is used for the ranking feature value may be a two-dimensional distance in the infrared image or may be a three-dimensional distance in the three-dimensional space.

The feature value F(t) is not influenced very much by the scale conversion and the minute changes, which is an advantage. FIG. 5A indicates the body parts acquired by an image, FIG. 5B indicates the body parts acquired when the image in FIG. 5A is enlarged, and FIG. 5C indicates the body parts when the body parts in FIG. 5A are slightly changed. As FIGS. 5A and 5B indicate, the ranking feature values are not changed even if the scale of the positions of the body parts changes. Further, as FIGS. 5A and 5C indicate, the ranking feature values are not influenced very much by the minute changes of the body parts. In other words, the feature value F(t) depends only on the ranking of the distance among body parts, and does not change even if a scale change such as zoom in and zoom out is generated, and the feature value F(t) is also constant even if the positions of the body parts slightly change, as long as this change does not influence the ranking of the distance of the body parts. Because of this characteristic, the influence of various changes which are generated in the behavior of the occupant in the vehicle is estimated, such as the horizontal shift of the seat position, physical constitution of the occupant, position and direction of the camera, and estimation error of the position of a body part in deep learning, can be suppressed.

By the above processing in steps S11 and S12, the feature value F(t) is determined for one frame of images I(t). Then by repeating the loop L1, this processing is executed for each frame of the input moving image.

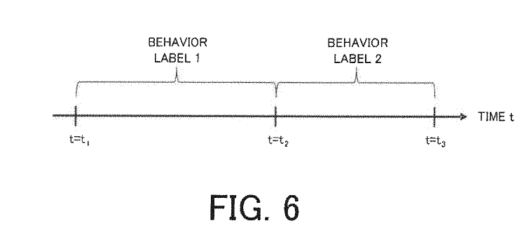

In step S13, the true value assigning unit 151 assigns a behavior label l (=1, 2, . . . , L) at each timing t, as indicated in FIG. 6. In concrete terms, a timing tₛ at which a certain behavior l (=1, 2, . . . , L) started and a timing to when this behavior ended, are assigned, such as assigning the behavior label 1 for timing t=t₂ to t₂, the behavior label 2 for timing t=t₂ to t₃, and the behavior label 3 for timing t=t₃ to t₄. Here L indicates a number of behavior labels to be identified, and is appropriately determined in accordance with the application to be implemented. The behavior label (correct label) may be manually input to the true value assigning unit 151 by the user (human). Further, the behavior label may be assigned to each frame of the input data. Non-limiting examples of the behavior labels include a steering wheel operation, an adjustment of a rear view mirror, an adjustment of a control panel, wearing or removing a seat belt, a smartphone operation, and eating and drinking. The true value assigning unit 151 corresponds to the correct behavior input unit of the present invention.

The processing of the loop L2 constituted by steps S14 and S15 is performed for each of time windows Δt which are set on the time axis. For example, a time window in the i-th processing is set in the t=Ti to Ti+Δt range. Here the size of the time window Δt can be determined by trial and error in accordance with an application to be implemented. The increment of Ti may be the same as or larger than the time step of the input image.

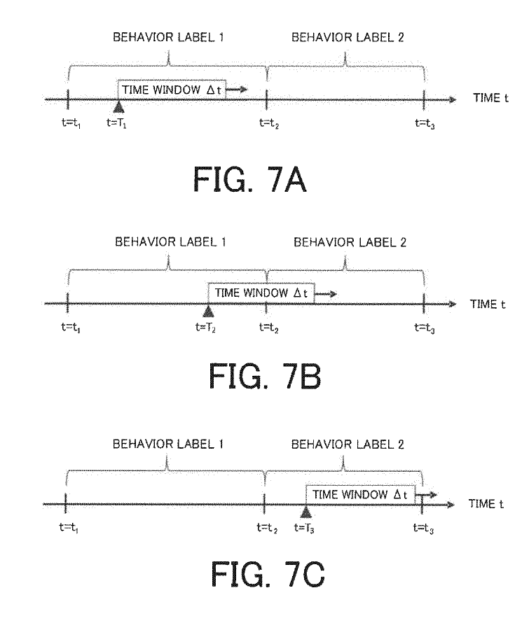

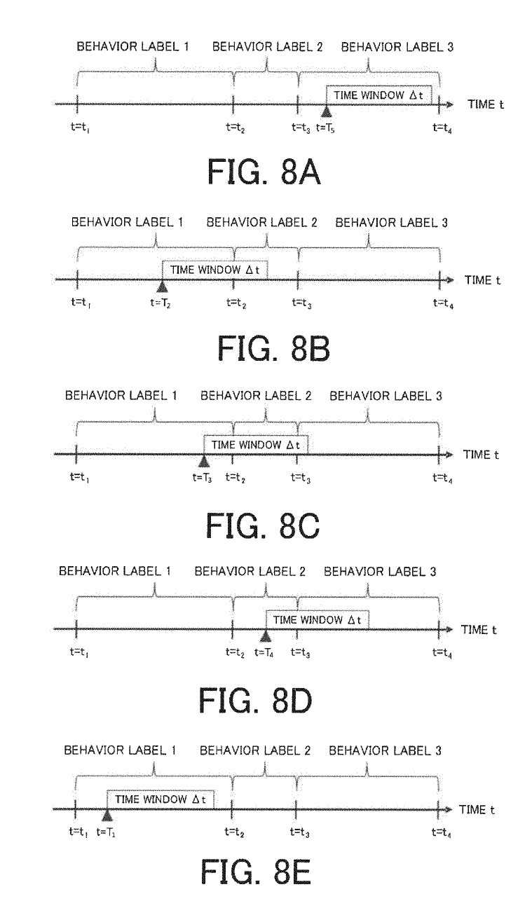

In step S14, the probability distribution calculating unit 153 calculates the probability distribution Pₜᵣ(t) for each time window, as illustrated in FIGS. 7A to 7C and FIGS. 8A to BE. The probability distribution Pₜᵣ(t) is determined as a distribution of a ratio of each behavior label (probability) in the time window from timing t to timing t+Δt.

For example, a case when the number of behavior labels assigned by the true value assigning unit 151 is two, namely, the behavior labels 1 and 2 (L=2), is considered. In FIG. 7A, one behavior label l is assigned in time t=T₁ to T₁+Δt, hence the probability distribution Pₜᵣ (t=T₁) is determined as Pₜᵣ(t=T)=(1, 0). In FIG. 7B, two behavior labels 1 and 2 coexist in time t=T₂ to T₂+Δt, hence the probability distribution Pₜᵣ(t=T₂) is determined as Pₜr(t=T₂)=((t₂−T₂)/Δt, (T₂+Δt−t₂)/Δt). Further, in FIG. 7C, one behavior label 2 is assigned in time t=T₃ to T₃+Δt, hence the probability distribution Pₜᵣ(t=T₃) is determined as Pₜᵣ(t=T₃)=(0, 1).

For another example, a case when the number of the behavior labels assigned by the true value assigning unit 151 is three, namely, the behavior labels 1, 2 and 3 (L=3), is considered. In FIG. 8A, one behavior label 1 is assigned in time t=T₁ to T₁+Δt, hence the probability distribution Pₜᵣ(t=T₁) is determined as Pₜr(t=T₁)=(1, 0, 0). In FIG. 8B, two behavior labels 1 and 2 coexist in time t=T₂ to T₂+Δt, hence the probability distribution Pₜr(t=T₂) is determined as Pₜᵣ(t=T₂)=((t₂−T₂)/Δt, (T₂+Δt−t₂)/Δt, 0). In FIG. 8C, three behavior labels 1, 2 and 3 coexist in time t=T₃ to T₃+Δt, hence the probability distribution Pₜᵣ=(t=T₃) is determined as Pₜᵣ(t=T₃)=((t₂−T₂)/Δt, (t₃−t₂)/Δt, (T₃+Δt−t₃)/Δt). Further, in FIG. 8D, two behavior labels 2 and 3 coexist in time t=T₄ to T₄+Δt, hence the probability distribution Pₜr(t=T₄) is determined as Pₜᵣ(t=T₄)=(0, (t₃−T₄)/Δt, (T₄+Δt−t₃)/Δt). Furthermore, in FIG. 8E, one behavior label 3 is assigned in time t=T₅ to T₅+Δt, hence the probability distribution Pₜᵣ(t=T₅) is determined as Pₜᵣ(t=T₅)=(0, 0, 1).

Here a case of a number of behavior labels is two or three (L=2 or 3) was described as an example, but the probability distribution Pₜᵣ(t) can be calculated as a ratio of the time of each behavior label with respect to the time window, regardless a number of behavior labels L.

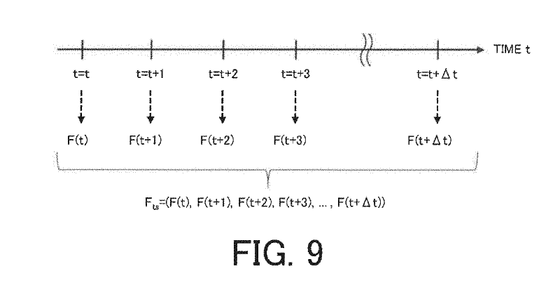

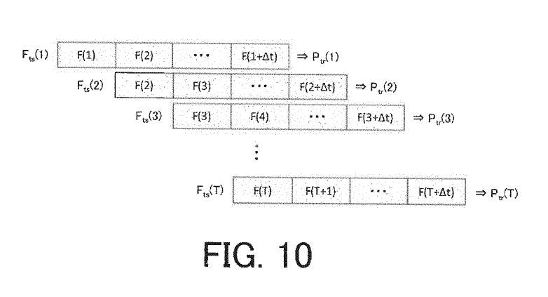

In step S15, as illustrated in FIG. 9, the time-series feature value calculating unit 154 calculates the feature value F(t), F(t+1), F(t+2), . . . , F(t+Δt) at each timing from timing t to timing t+Δt, and calculates the time-series feature value Fₜ₅(t)=(F(t), F(t+1), F(t+2), . . . , F(t+Δt)) at the timing t by connecting these feature values in the time direction. The time-series feature value Fₜₛ(t) corresponds to the second feature value of the present invention, and the time-series feature value calculating unit 154 corresponds to the second feature value calculating unit of the present invention.

By the processing in steps S14 and S15, the probability distribution Pₜᵣ(t) and the time-series feature value FₜS(t) are calculated for one time window. Then by repeating the loop L2, this processing is executed for all periods of the input moving image.

The probability distribution learning unit 155 learns a classifier C₁ to estimate the probability distribution at the timing t, that is, Pₜᵣ(t) (t=1, 2, . . . , T), acquired by the probability distribution calculating unit 153, using the time-series feature value Fₜₛ(t)=(F(t), F(t+1), F(t+2), . . . , F(t+Δt)) (t=1, 2, . . . , T) acquired by the time-series feature value calculating unit 154 as input, as illustrated in FIG. 10. Here T denotes a number of learning samples (pair of the infrared image and the depth information) to learn the classifier C₁ for the behavior label l (=1, 2, . . . , L), and T is determined by trial and error in accordance with the number of behavior labels L to be identified, and a degree of difficulty of identification for each behavior label (degree of difficulty is higher as a number of behavior labels, which appear to be similar but in fact are quite different, is higher).

To learn the classifier C₁, a time-series type neural network, to classify the time-series data, may be used. Such a learning algorithm is, for example, long short term memory (LSTM), which can store not only short term information of the time series data, but also long term information, as stated in Non Patent Literature 6. LSTM is an extension of recurrent neural network (RNN), and is a neural network in which a unit in the intermediate layer of RNN is replaced with a block having a memory called an LSTM block, and three gates. LSTM has various extensions, and the methods stated in Non Patent Literature 7 and Non Patent Literature 8, for example, may be used. The learning algorithm that can be used here is not limited to LSTM, and any conventional algorithm can be used as long as the time-series data can be classified.

With the above processing, the learning of the classifier C₃ by the learning apparatus 2 completes.

Behavior Recognition Processing

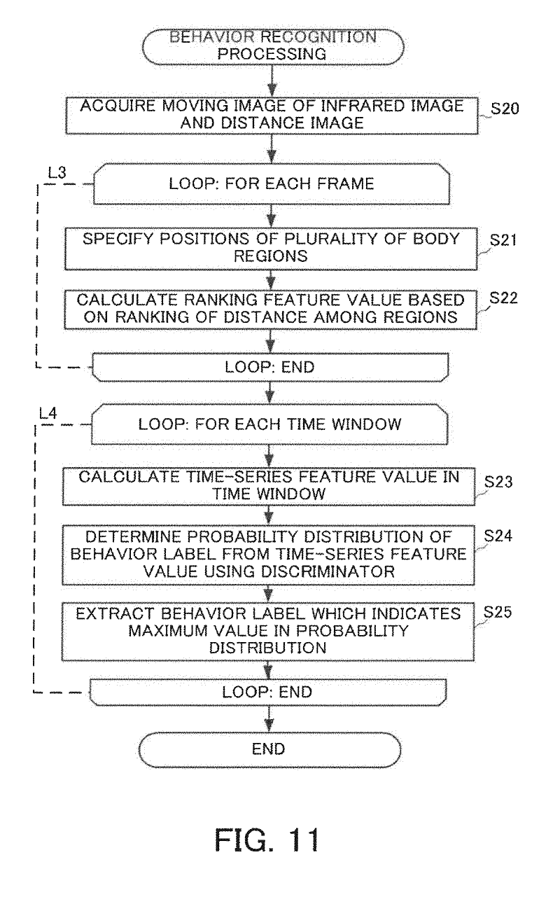

The behavior recognition processing performed by the behavior recognition apparatus 1 will be described next. The identifying unit 16 of the behavior recognition apparatus 1 uses the classifier C₁ learned by the learning apparatus 2. FIG. 11 is a flow chart depicting the flow of the behavior recognition processing.

In step S20, the infrared image input unit 11 and the depth information input unit 12 of the behavior recognition apparatus 1 acquire the moving images of the infrared image and the depth information (distance image) on the behavior of the recognition subject. The acquisition of the infrared image and the depth information is essentially the same as the case of the learning processing.

The processing of the loop L3, constituted by steps S21 and S22, is performed for each frame of the input moving image.

In step S21, the body part detecting unit 13 detects two-dimensional positions of body parts. In step S22, the feature value calculating unit 14 calculates a ranking feature value based on the ranking of the distance among body parts. The processing in steps S21 and S22 are the same as the processing in steps S11 and S12 in the learning processing.

The processing of the loop L4, constituted by steps S23 to S25, is performed for each time window (t=t′ to t′+Δt, t′=1, 2, . . . , T′), which is set for the input moving image.

In step S23, the feature value calculating unit 14 calculates the time-series feature value Fₜₛ(t′)=(F(t′), F(t′+1), F(t′+2), . . . , F(t′+Δt)) (t′=1, 2, . . . , T′) generated by connecting the ranking feature values in the time window (t=t′ to t′+Δt) in the time direction. This processing is the same as the processing in step S15 in the learning processing.

In step S24, the identifying unit 16 calculates the probability distribution Pₜₑ(t′) (t′=1, 2, . . . , T′) for the behavior label l (=1, 2, . . . , L) by inputting the time-series feature values Fₜₛ(t′)=(F(t′), F(t′+1), F(t′+2), . . . , F(t′+Δt)) (t′=1, 2, . . . , T′) to the classifier C₁ acquired by the learning unit 15. In step S25, the identifying unit 16 converts the acquired probability distribution Pₜₑ(t′) (t′=1, 2, . . . , T′) into a behavior label lₒᵤₜ(t′) (t′=1, 2, . . . , T′) which indicates the maximum value at each timing t′ (=1, 2, . . . , T′) in the probability distribution, and outputs the behavior label lₒᵤₜ(t′) to outside the behavior recognition apparatus 1. Here the time T′ indicates a number of identification target samples (pair of infrared image and depth information) of which behavior labels are unknown.

The behavior recognition result lₒᵤₜ(t′) (l=1, 2, . . . , L, t′=1, 2, . . . , T′) of the occupant in the vehicle acquired like this is transferred to a host apparatus which uses the behavior recognition apparatus 1, and is applied to various applications to which the behavior of the occupant in the vehicle is input. For example, risky behavior of the occupant in the vehicle, such as smartphone operation, eating and drinking, is recognized and checked against the traveling state of the vehicle, whereby this behavior is appropriately called attention to.

In Embodiment 1, the classifier to determine the probability distribution of the correct behavior based on the time-series is learned, using a combination of: the time-series feature value generated by connecting the feature value at each timing in the time window; and the probability distribution of the correct behavior in the time window, as the learning data. Since the behavior recognition is performed based on the time-series feature value like this, the behavior recognition can be performed considering the time-series change of the state of the occupant in the vehicle. In other words, even a behavior which cannot be identified by a state of one timing alone can be appropriately identified. Further, the accuracy of recognizing the behavior of the occupant in the vehicle, depending on the time-series change of the body posture, can be improved, such as entering/exiting the vehicle, wearing/removing the seatbelt, steering operation during a left/right turn, and the up/down/left/right screen swipe operation to operate the vehicle navigation system.

Further, the ranking of the distance among parts is used as the feature value at each timing, hence highly robust behavior recognition can be performed. This is because ranking of the distance does not change even if a scale change such as zoom in and zoom out, rotation, or parallel shift is generated in the images, and is not influenced very much by minute changes of the parts. Because of these characteristics, the influence of various changes which are generated when the behavior of the occupant of the vehicle is estimated, such as a horizontal shift of the seat position, physical constitution of the occupant, position and direction of the camera, and estimation error of the position of a body part in deep learning, can be suppressed.

### Embodiment 2

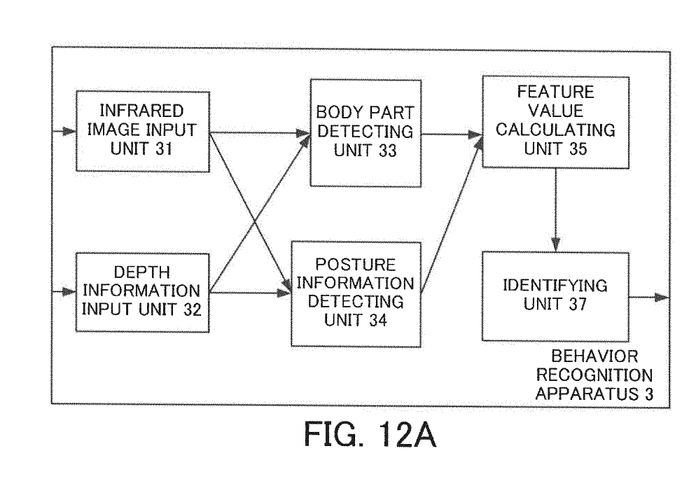

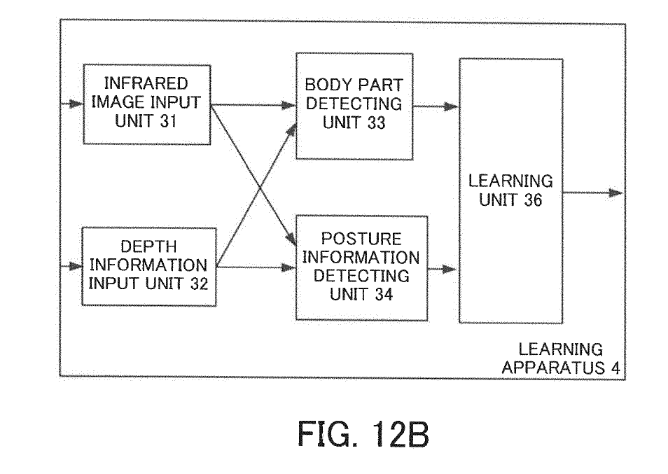

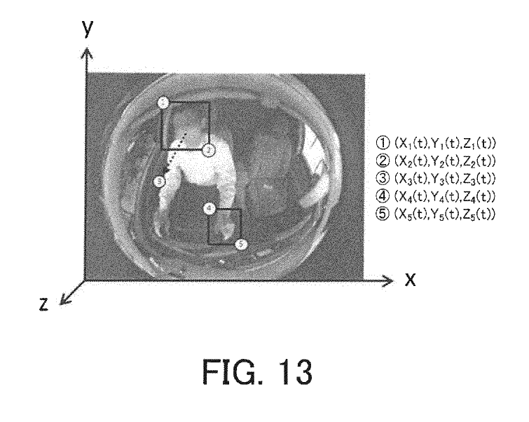

Embodiment 2 of the present invention will be described with reference to FIGS. 12A and 12B and FIG. 13. FIGS. 12A and 12B are block diagrams depicting a behavior recognition apparatus 3 and a learning apparatus 4 according to Embodiment 2. The behavior recognition apparatus according to Embodiment 2 can be implemented by a semiconductor integrated circuit (LSI).

As illustrated in FIG. 12A, the behavior recognition apparatus 3 has: an infrared image input unit 31, a depth information input unit 32, a body part detecting unit 33, a posture information detecting unit 34, a feature value calculating unit 35 and an identifying unit 37. As illustrated in FIG. 12B, the learning apparatus 4 has: an infrared image input unit 31, a depth information input unit 32, a body part detecting unit 33, a posture information detecting unit 34 and a learning unit 36. These composing elements correspond to the functions performed by the behavior recognition apparatus 3 and the learning apparatus 3 respectively. In Embodiment 2, only the differences from Embodiment 1 will be described.

In Embodiment 1, the body part detecting unit 13 detects the positions of the body parts of the occupant in the vehicle, and calculates the feature value based only on the ranking relationship of the acquired distances among body parts, but Embodiment 2 is characterized in that the feature value is calculated not only on the ranking relationship of the distances among the body parts, but also on the orientation of the face of the occupant in the vehicle, the position of the head region (where the head region of the occupant in the vehicle is located in the image space), and the position of the hand region (where the hand region of the occupant in the vehicle is located in the image space). The orientation of the face, the position of the head region and the position of the hand regions of the occupant in the vehicle are examples of the information on the posture of the occupant in the vehicle.

Each functional unit of Embodiment 2 will be described next. The infrared image input unit 31, the depth information input unit 32 and the body part detecting unit 33 perform the same processing as the equivalent functional units of Embodiment 1 respectively.

The posture information detecting unit 34 extracts the occupant information I(t) based on: two points of r₁=(X₁(t), Y₁(t), Z₁(t)) and r₂=(X₂(t), Y₂(t), Z₂(t)), which represent a rectangular region including the head region of the occupant in the vehicle; a direction vector r₃ (X₃(t), Y₃(t), Z₃(t)) indicating the orientation of the face of the occupant in the vehicle; and two points of r₄=(X₄(t), Y₄(t), Z₄(t)) and r₅=(X₅(t), Y₅(t), Z₅(t)) which represent a rectangular region including the hand region of the occupant in the vehicle, and outputs this occupant information I(t) to the feature value calculating unit 25. In concrete terms, the posture information P(t) is acquired by connecting the three-dimensional information in the dimensional direction as indicated in Expression (2).

[Math. 2]

P(t)=(r₁,r₂,r₃,r₄,r₅) (2)

For the posture information P(t)=(r₁, r₂, r₃, r₄, r₅) of the occupant in the vehicle, the classifier C2, to estimate the posture information P(t)=(r₁, r₂, r₃, r₄, r₅) of the occupant in the vehicle, is configured in advance, using the large volume of learning data, based on: two points of r₁=(X′₁(t), Y′₁(t), Z′₁(t)) and r₂=(X′₂(t), Y′₂(t), Z′₂(t)), which represent a rectangular region including the head region of the occupant in the vehicle; a direction vector r₃=(X′₃(t), Y′₃(t), Z′₃(t)) indicating the orientation of the face of the occupant in the vehicle; and two points of r₄=(X′₄(t), Y′₄(t), Z′₄(t)), and r₅=(X′₅(t), Y′₅(t), Z′₅(t)) which represent a rectangular region including the hand region of the occupant in the vehicle, as stated in Non Patent Literature 4, for example, and the posture information P(t)=(r₁, r₂, r₃, r₄, r₅) of the occupant in the vehicle at a certain timing t is estimated using the acquired classifier C₂.

The head region and the hand regions need not be specified as rectangular regions, and may be specified as polygonal regions or as circular (including elliptical) regions. The method of specifying the regions is not especially limited, and the center position and the size of the region may be specified instead of specifying a vertex position of the region.

The feature value calculating unit 35 calculates the feature value F(t) based on the ranking feature value, which indicates the ranking of the distance among M number of parts of the occupant in the vehicle at the timing t in the two-dimensional coordinates (xₘ(t), yₘ(t)) (m=1, 2, . . . , M) acquired by the body part detecting unit 33, and the posture information P(t) at the timing t acquired by the posture information detecting unit 24, and outputs the calculated feature value F(t) to the learning unit 15 and the identifying unit 16. In concrete terms, the feature value F(t) can be calculated using Expression (3). The ranking feature value is determined in the same manner as Embodiment 1.

[Math. 3]

F(t=(R(D(1,2)),R(D(1,3)), . . . ,R(D(8,9)),R(D(9,10)),P(t)) (3)

In Embodiment 2, the above mentioned feature value F(t) corresponds to the first feature value, and both the body part detecting unit 33 and the posture information detecting unit 34 correspond to the occupant information acquiring unit.

The learning unit 36 and the identifying unit 37 are the same as in Embodiment 1, except that the feature value used in Embodiment 2 is the time-series feature value generated by connecting the feature values determined by Expression 3 in a time-series. In other words, the learning unit 36 determines the probability distribution of the behavior label in each time window, and learns the classifier C₁ to determine the probability distribution of the behavior labels from the time-series data, using a set of time-series feature values in the same time window and probability distribution, as the learning data. Further, the identifying unit 37 determines the probability distribution of the behavior labels corresponding to the time-series feature value using the classifier C₁, and determines the behavior label which indicates the maximum value as the behavior in the target time window.

According to Embodiment 2, the behavior recognition can be performed considering the position and orientation of the face, and the positions of the hands of the occupant in the vehicle. Therefore a more accurate recognition can be performed. For example, according to the behavior of the occupant in the vehicle, not only the posture of the body, but also the posture of the hands and fingers, the position of the face, the orientation of the face, line of sight and the like change as well. Therefore the accuracy of recognizing the behavior of the occupant in the vehicle, such as entering/exiting the vehicle, wearing/removing the seatbelt, steering operation during a left/right turn, and the up/down/left/right screen swipe operation to operate the vehicle navigation system, can be further improved.

(Modifications)

In the above description, the two-dimensional position (xₘ(t), yₘ(t)) is determined as a position of a body part, hence a distance on the xy plane is used for the distance between parts as well. However, a three-dimensional position of a body part may be determined, and a distance in the three-dimensional space may be used for the distance between parts as well.

A position of a body part used in the learning processing and the behavior recognition processing may be determined in best possible way. This means that not only the algorithm used for detecting a part is not limited to a specific algorithm, but also a part may be detected manually. In the case of the behavior recognition processing, however, it is preferable that the body parts be detected by machine in order to perform the processing in real-time.

The behavior recognition apparatuses 1 and 3 and the learning apparatuses 2 and 4 are not limited to be implemented by a semiconductor integrated circuit (LSI), but may be implemented by a computer which has a general purpose microprocessor and memory to execute a program. In the above description, the behavior recognition apparatus 1 or 3 and the learning apparatus 2 or 4 are assumed to be different apparatuses, but the learning mode and the recognition mode may be switched in one apparatus.

What is claimed is:

1. A behavior identification apparatus that identifies a behavior of an occupant in a vehicle based on a moving image obtained by imaging an inside of the vehicle, the behavior identification apparatus comprising:
an occupant information acquiring unit configured to acquire occupant information on the occupant in the vehicle, from each frame image of the moving image;
a first feature value calculating unit configured to calculate, for each frame image of the moving image, a first feature value, which is a feature value based on the occupant information;
a second feature value calculating unit configured to calculate a second feature value, which is a feature value generated by connecting the first feature values for the frame images in a predetermined period; and
an identifying unit configured to identify the behavior of the occupant in the vehicle using a classifier which is learned in advance so as to determine, from the second feature value, a probability distribution of behavior labels in a predetermined period, and the second feature value calculated by the second feature value calculating unit.

2. The behavior identification apparatus according to claim 1,
wherein the occupant information includes positions of a plurality of body parts of the occupant in the vehicle, and
the first feature value is a feature value based on the relationship of the positions of the body parts.

3. The behavior identification apparatus according to claim 2,
wherein the first feature value is a feature value based on the ranking of the distance among the body parts.

4. The behavior identification apparatus according to claim 2,
wherein the occupant information further includes at least one of a position of a head region, an orientation of a face, and positions of hand regions, and
the first feature value is generated by combining a feature value based on the relationship of the positions of the body parts, and at least one of the position of the head region, the orientation of the face, and the positions of the hand regions.

5. The behavior identification apparatus according to claim 1,
wherein the moving image includes an infrared image and a distance image.

6. The behavior identification apparatus according to claim 1,
wherein the identifying unit determines, as the behavior of the occupant in the vehicle, a behavior label indicating a maximum value in the probability distribution acquired by the classifier.

7. A learning apparatus, comprising:
an occupant information acquiring unit configured to acquire occupant information on an occupant in a vehicle from each frame image of a moving image obtained by imaging an inside of the vehicle;
a correct behavior input unit configured to acquire a correct behavior of the occupant in the vehicle in each frame image;
a probability distribution calculating unit configured to calculate a probability distribution which indicates a ratio of each correct behavior performed by the occupant in the vehicle in the frame images in a predetermined period;
a first feature value calculating unit configured to calculate, for each frame image, a first feature value which is a feature value based on the occupant information;
a second feature value calculating unit configured to calculate a second feature value which is a feature value generated by connecting the first feature values for the frame images in a predetermined period; and
a learning unit configured to learn a classifier which identifies a probability distribution of each behavior performed by the occupant in the vehicle for a predetermined period, based on the second feature value calculated by the second feature value calculating unit, and the probability distribution calculated by the probability distribution calculating unit.

8. The learning apparatus according to claim 7,
wherein the occupant information includes positions of a plurality of body parts of the occupant in the vehicle, and
the first feature value is a feature value based on the relationship of the positions of the body parts.

9. The learning apparatus according to claim 8,
wherein the first feature value is a feature value based on the ranking of the distance among the body parts.

10. The learning apparatus according to claim 8,
wherein the occupant information further includes at least one of a position of a head region, an orientation of a face, and positions of hand regions, and
the first feature value is generated by combining a feature value based on the relationship of the positions of the body parts, and at least one of the position of the head region, the orientation of the face, and the positions of the hand regions.

11. The learning apparatus according to claim 7,
wherein the moving image includes an infrared image and a distance image.

12. A behavior identification method for identifying a behavior of an occupant in a vehicle based on a moving image obtained by imaging an inside of the vehicle, the behavior identification method comprising:
an occupant information acquiring step of acquiring occupant information on the occupant in the vehicle, from each frame image of the moving image;
a first feature value calculating step of calculating, for each frame image of the moving image, a first feature value, which is a feature value based on the occupant information;
a second feature value calculating step of calculating a second feature value, which is a feature value generated by connecting the first feature values for the frame images in a predetermined period; and
an identifying step of identifying the behavior of the occupant in the vehicle using a classifier which is learned in advance so as to determine, from the second feature value, a probability distribution of behavior labels in a predetermined period, and the second feature value calculated in the second feature value calculating step.

13. A learning method, comprising:
an occupant information acquiring step of acquiring occupant information on an occupant in a vehicle from each frame image of a moving image obtained by imaging an inside of the vehicle;
a correct behavior inputting step of acquiring a correct behavior of the occupant in the vehicle in each frame image;
a probability distribution calculating step of calculating a probability distribution which indicates a ratio of each correct behavior performed by the occupant in the vehicle in the frame images in a predetermined period;
a first feature value calculating step of calculating, for each frame image, a first feature value which is a feature value based on the occupant information;
a second feature value calculating step of calculating a second feature value which is a feature value generated by connecting the first feature values for the frame images in a predetermined period; and
a learning step of learning a classifier which identifies a probability distribution of each behavior performed by the occupant in the vehicle for a predetermined period, based on the second feature value calculated in the second feature value calculating step, and the probability distribution calculated in the probability distribution calculating step.

14. A non-transitory computer readable storing medium recording a computer program for causing a computer to perform the method according to claim 12.

15. A non-transitory computer readable storing medium recording a computer program for causing a computer to perform the method according to claim 13.
